(19) United States
(12) Patent Application Publication
(10) Pub. No.: US 2012/0210632 A1
(43) Pub. Date: Aug. 23, 2012

(54) Method and Apparatus for High Temperature Brine Phase Reactions

(76) Inventors: Glenn T. Hong, Westborough, MA (US); Michael H. Spritzer, San Diego, CA (US)

(21) Appl. No.: 13/030,979

(22) Filed: Feb. 18, 2011

(51) Int. Cl. C10L 1/00; G05D 9/00

(52) U.S. Cl. 44/307; 422/106

(57) ABSTRACT

The present invention features the use of salt-water mixtures to form brine reaction phases at supercritical temperatures, i.e., greater than 374° C., and at pressures of less than 500 bar. The conditions utilized allow high reaction rates to be attained in a dense medium at moderate pressures and temperatures.

### FIELD OF THE INVENTION

The present invention pertains to the field of supercritical water technologies. In particular, the present invention pertains to supercritical water gasification (SCWG) and supercritical water liquefaction (SCWL), in which fuel compounds or other desired products are made from a feedstock such as biomass. The present invention also pertains to the process of supercritical water oxidation (SCWO), in which waste materials are converted into innocuous mineral byproducts. The invention is particularly, but not exclusively, useful for synthesis reactions that can be carried out in a brine phase at temperatures above the critical point of water.

### BACKGROUND OF THE INVENTION

U.S. Pat. No. 4,113,446, issued Sep. 12, 1978, to Modell et al., discloses a process known as supercritical water gasification (SCWG). In this process, organic materials are contacted with water at supercritical conditions (T>374° C. and P>221 bar) and converted to gaseous materials comprised primarily of CH₄, H₂, CO₂ and CO. For feed materials such as biomass, the solvating properties of supercritical water result in reduced formation of tar and char as compared to conventional, low pressure gasification. Hong and Spritzer (Proceedings of the 2002 U.S. DOE Hydrogen Program Review NREL/CP-610-32405, May 2002) describe a variant of the SCWG process in which a portion of the feedstock is oxidized within the gasifier in order to provide the heat needed for gasification. This process is known as supercritical water partial oxidation (SWPO).

U.S. Pat. No. 4,338,199, issued Jul. 6, 1982, to Modell, discloses a process known as supercritical water oxidation (SCWO). In this process an oxidant such as air or oxygen is added to the reaction mixture so that oxidation of organic feedstock occurs at conditions supercritical in temperature and pressure. SCWO has been shown to give complete oxidation of virtually any organic compound in a matter of seconds at 550-700° C. and 250 bar. A process related to SCWO, known as supercritical temperature water oxidation (STWO), can provide similar oxidation effectiveness for certain feedstocks but at lower pressure. This process has been described in U.S. Pat. No. 5,106,513, issued Apr. 21, 1992, to Hong, and utilizes temperatures in the range of 650° C. and pressures between 25 and 220 bar. As with SCWO, the overall goal of the process may be waste destruction, energy generation, or production of chemicals.

In addition to the above processes, supercritical water liquefaction (SCWL) may be used to produce liquid products at generally lower temperatures than SCWG, and supercritical water synthesis (SCWS) reactions may be used for various conversions of organic materials.

A feature of the preceding SCW processes is that due to the combination of temperatures and pressures used, e.g. 400-700° C. and 220-350 bar, the reactions are carried out in a supercritical steam phase with a density in the range of 60-500 kg/m³. This relatively low density medium (compared to liquid water) has the advantage of allowing complete miscibility of organics and gases with the steam phase, but also has disadvantages in terms of precipitation and plugging by salts, incompatibility with homogeneous catalysis (which precipitate out), and reduced heat transfer rates. In addition, reactions dependent on ionic-type mechanisms are retarded or prevented.

Both SCWO and SCWG have counterparts that operate in an aqueous liquid phase at subcritical temperatures. In the case of oxidation, the process known as wet oxidation has been used for the treatment of aqueous streams since the 1950s (see e.g. U.S. Pat. No. 2,665,249, issued Jan. 5, 1954, to Zimmermann). It involves the addition of an oxidizing agent, typically air or oxygen, to an aqueous waste stream at elevated temperatures and pressures, with the resultant “combustion” of oxidizable materials directly within the aqueous phase. The wet oxidation process is characterized by operating pressures of 30 to 250 bar and operating temperatures of 150 to 370° C. Typically, the amount of oxidant required to oxidize the waste exceeds the solubility limit of oxygen or air, so that both gaseous and liquid phases are present in the reactor. Because oxidation is carried out primarily in the liquid phase, some provision for mixing must be made to facilitate transfer of oxygen to the liquid phase. Bubble columns, baffles, packed beds and stirrers have been used to achieve this goal. Reaction is primarily carried out in the liquid phase since gas phase oxidation is quite slow. Thus, the reactor operating pressure is typically maintained at or above the saturated water vapor pressure, so that at least part of the water is present in liquid form. The largest single application of wet oxidation is for the conditioning of municipal sludge. The oxidation achieved in this process is only 5 to 15% complete, the primary objective being sterilization and disruption of the organic matrix to improve the dewatering properties of the sludge. Following wet oxidation, the sludge is used for soil improvement or landfill, or is incinerated. Other uses of wet oxidation are for the treatment of night soil, pulp and paper mill effluents, regeneration of activated carbon, and treatment of chemical plant effluents. In these applications higher temperatures are used but oxidation is still typically at most 90% complete. Wet oxidation is limited not only in the degree of oxidation achievable, but also by its inability to handle refractory compounds. Because of the low temperatures relative to those found in normal combustion, reaction times are on the order of an hour, rather than seconds. Even with these extended reaction times many refractory organics are poorly oxidized. One means for improving the low temperature oxidation has been the usage of homogeneous or heterogeneous catalysts in the liquid stream. The process is significantly complicated by this approach because of catalyst deactivation, attrition, and recovery.

Gasification in a subcritical aqueous phase, referred to as wet gasification, has been developed by Elliott et al. at the Pacific Northwest National Laboratory (Catalytic Hydrothermal Gasification of Lignin-Rich Biorefinery Residues and Algae, PNNL Final Report 18944, October 2009). Typical conditions for this process are 350° C. and 208 bar. Due to the low temperature, a catalyst must be used; even so, residence times of 15-20 minutes are required as compared to one to several minutes at supercritical temperatures.

In view of the preceding limitations of the existing art, it is an object of the present invention to provide a method and apparatus for using a reaction phase with liquid-like densities wherein the reaction phase retains the advantages of high reaction rates provided by supercritical water temperatures without the need for excessively high pressures. The combination of high density and high reaction rates imparts numerous benefits over the prior art, which entails low density or slow reaction rates.

### SUMMARY OF THE INVENTION

In accordance with the present invention, a method and apparatus for processing a feed material includes a reactor vessel that is formed with a chamber. More particularly, the chamber is constructed to hold a brine phase in which feed material reacts to produce an effluence of gaseous or liquid byproducts. For the present invention, the brine phase is heated to a temperature that is greater than the supercritical water temperature of 374° C., and it is held under a relatively low pressure that is less than about 500 bar. Importantly, within the chamber of the reactor vessel, conditions are such that the brine phase has a density that is greater than about 500 kg/m³. Preferably, however, the density will be greater than about 700 kg/m³.

Structurally, the apparatus of the present invention includes a level controller to maintain the level of the brine phase in the upper part of the vessel. It may also include a downcomer pipe that is connected from the source of feed material into fluid communication with the chamber of the reactor vessel. With this connection, the downcomer pipe is used to introduce the feed material into the brine phase, where it will react to produce the effluence. In addition to the downcomer pipe, the apparatus has an exit pipe that is connected in fluid communication with the chamber for removing the gaseous effluence from the chamber.

In a preferred embodiment of the present invention, the brine phase and a gaseous effluence that is generated during the reaction of the feed material will coexist in the chamber. Consequently, a liquid/vapor interface is created between the gaseous effluence and the brine phase. In this case, a downcomer pipe extends from the source of feed material, through the gaseous effluence, and past the interface into the brine phase. Thus, the downcomer pipe is in direct fluid communication with only the brine phase. On the other hand, inside the chamber of the reactor vessel, the gas exit pipe is in fluid communication with only the gaseous effluence.

In addition to the structural components mentioned above, the apparatus of the present invention may also include several other components that are in fluid communication with the chamber of the reactor vessel. These additional components include an injection pipe that can be connected to the downcomer pipe for injecting super-heated water or brine into the feed material. As envisioned for the present invention, this injected fluid will have a temperature that is greater than 374° C., and will serve to rapidly preheat the feed material. Additionally, the apparatus can include an injection pipe that is connected in fluid communication with the chamber of the reactor vessel. In particular, the injection pipe is used to inject water or brine into the brine phase for control of the brine phase. Here again, the injected fluid preferably has a temperature that is greater than 374° C. Further, an oxidant pipe can be joined in fluid communication with the chamber of the reactor vessel for use in adding an oxidant to the brine phase. Still further, a drain pipe can be provided for removing residual solids and excess dissolved materials from the brine phase.

The brine phase inside the chamber of the reactor vessel is comprised of water mixed with at least one soluble inorganic compound. Preferably, the inorganic compound for the brine phase is selected from a group comprising salts, oxide compounds and hydroxide compounds. Also, a catalyst may be included in the brine phase in the reactor vessel. For one embodiment of the present invention the catalyst is an alkaline compound selected from a group comprising K₂CO₃ and NaOH. As an alternate embodiment, the catalyst may be based on a precious metal or a transition metal.

The brine phase inside the reactor vessel is maintained at a temperature greater than 374° C., and a pressure less than about 500 bar. Under these conditions, the brine phase will typically have a density that is greater than 700 kg/m³. The feed material is then introduced into the reactor vessel for reaction within the brine phase to produce the effluence. In order to accelerate and facilitate the reaction, water or brine at supercritical temperature can be injected into the feed material as it is being introduced into the reactor vessel. Further, the methodology of the present invention envisions removing residual solids and excess dissolved materials from the brine phase, and augmenting the brine phase with an oxidant. In some embodiments, the purpose of the apparatus and method is to collect or dispose of the product effluence that results from the reaction.

For simplicity in the following discussion, temperature and pressure will be referenced to the critical conditions for pure water, e.g. temperatures supercritical for water will be termed “supercritical temperature”. The key feature of the present invention is the use of soluble inorganic compounds, typically salts, but also oxide or hydroxide compounds, in mixtures with water to form dense brine reaction phases, i.e., with densities >500 kg/m³, at supercritical temperatures, i.e., >374° C., henceforth termed “supercritical brines”. The high temperatures allow high reaction rates to be attained in a dense medium. Depending on the desired reactions, particular potential advantages include the following:

A) Aqueous ionic reaction pathways can be carried out at supercritical temperatures;

B) Homogeneous catalysis at supercritical temperatures is enabled since catalytic salts can be solubilized along with the reactants;

C) Suspension of heterogeneous catalysts is facilitated by the dense reaction phase;

D) Use of precious metal catalysts may be avoided;

E) Salts can be selected to protect catalysts from poisoning, e.g., sulfur can be scavenged by the salt cations;

F) Soluble or insoluble additives may be introduced to the brine phase to protect catalysts from poisoning;

G) While supercritical pressures, i.e., >221 bar, will sometimes be desirable, dense reaction phases can also be maintained at supercritical temperatures, but subcritical pressures, i.e., <221 bar;

H) The presence of a dense phase yields high heat transfer rates, facilitating rapid heatup of feed materials and reducing the opportunity for tar and char formation;

I) The presence of high levels of soluble salts can help prevent deposition of low solubility salts; and

J) Combined with high reaction rates, the high density reaction phase allows small size reactors to be used.

These and other advantages will become apparent by means of the drawings and detailed description that follow.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a phase diagram for a binary water-salt system showing phase relationships for NaCl—H₂O at 450° C. for a range of pressures and compositions;

FIG. 1B is a phase diagram as shown in FIG. 1A for K₂CO₃—H₂O;

FIG. 1C is a phase diagram as shown in FIG. 1A for Na₂CO₃—H₂O;

FIG. 2 is a phase diagram for a ternary water-salt system showing the effect of adding a second salt;

FIG. 3 is a phase diagram of a binary water-salt system showing examples of brine densities;

FIG. 4 illustrates the relative stability of several sulfide compounds;

FIG. 5 is a cross-section view of a reactor for use with the present invention; and

FIG. 6 shows the laboratory batch reactor setup used to obtain feasibility data for the present invention.

### DESCRIPTION OF THE PREFERRED EMBODIMENTS

As conventionally practiced, supercritical water (SCW) processes involve a reaction phase with a density of <500 kg/m³, and usually <100 kg/m³. For example, typical supercritical water oxidation (SCWO) conditions are 650° C. and 235 bar, for which the density of the SCW medium is −70 kg/m³. Likewise, typical conditions for high-temperature supercritical water gasification (SCWG) are 650° C. and 235 bar, again with a density of the SCW medium of ˜70 kg/m³, while typical conditions for low-temperature SCWG are 400° C. and 345 bar, for which the density of the SCW medium is ˜470 kg/m³. Attaining liquid-like densities for conventional SCW processes requires substantially increased pressures, with corresponding increases in equipment and operating costs. For example, to attain a density of 900 kg/m³ at 400° C. requires a pressure of about 4,000 bar or 60,000 psi. The key feature of the present invention consists of carrying out reactions in a dense reaction phase containing water at temperatures beyond the critical temperature of water, i.e., 374° C., in which the dense phase is maintained by a high level of dissolved salts, oxides or hydroxides. Such reaction phases will hereinafter be referred to as “supercritical brines” and typically possess a density in the range of 1,000 kg/m³, which is the density of normal liquid water. Through use of supercritical brines, reactions can be accelerated by supercritical temperatures while excessive pressures, nominally >500 bar, are avoided. In addition to the general feature of accelerated reactions, the use of supercritical brines has a number of subsidiary advantages that are described in the following paragraphs.

By means of the present invention, aqueous ionic reaction pathways can be carried out at supercritical temperatures. Examples of such reactions include acid- and base-catalyzed reactions. Such reactions may be especially favorable in supercritical brines due to the enhanced ion product of water at dense supercritical conditions. For example, the ion product of water at 450° C. and 1000 kg/m³ is nearly 10⁻⁸ (mol/kg)², almost 6 orders of magnitude higher than its ambient temperature liquid water value of 10⁻¹⁴ (mol/kg)², and about 14 orders of magnitude higher than its value of 10⁻²² (mol/kg)² in pure SCW at 450° C. and 250 bar (density ˜100 kg/m³). Thus, even though water is only a fractional component of the brine, relatively high concentrations of hydronium and hydroxyl ions will be present.

By means of the present invention, homogeneous catalysis at supercritical temperatures is enabled since catalytic salts can be solubilized along with the reactants. In some cases, the brine-forming solute may itself be the catalyst, as is the case for potassium carbonate. Alternatively, the homogeneous catalyst may be a soluble precious metal catalyst such as ruthenium trichloride. In addition, the dense reaction phase makes suspension of fine heterogeneous catalysts easier than with a typical low density SCW medium. The present invention is also compatible with fixed catalyst beds.

By means of the present invention, salts can be selected to protect precious metal catalysts from poisoning. For example, sulfur can be scavenged by the salt cations since sodium sulfide and potassium sulfide are more stable than ruthenium sulfide at the conditions of interest.

In the practice of SCWG it is well-known that formation of tar and char byproducts is minimized by rapid heatup to reaction temperatures. In the present invention the presence of a dense phase yields high heat transfer rates, facilitating rapid heatup of feed materials and reducing the opportunity for tar and char formation.

In the present invention, the presence of high levels of soluble salts can help prevent deposition of normally low solubility salts. This feature helps reduce operating problems due to solids accumulation and plugging.

In the present invention, the presence of high levels of soluble salts can allow brines at supercritical temperatures to persist at subcritical pressures. This feature can help reduce the capital and operating costs associated with a high-pressure process.

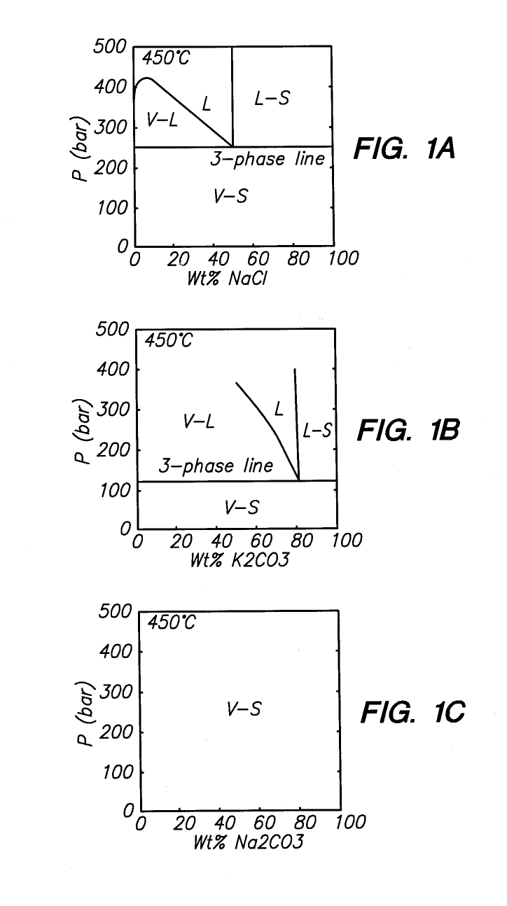

The preceding features of the invention are further illustrated with reference to the FIGS. 1-6.

FIGS. 1A-1C illustrate how suitable combinations of temperature, pressure and composition are selected for the present invention. FIG. 1A (adapted from Marrone and Hong, Supercritical Water Oxidation, in Environmentally Conscious Materials and Chemical Processing, M. Kutz ed., John Wiley & Sons, Inc., Hoboken, 2007) is a phase diagram that shows phase equilibrium relationships for the binary system NaCl—H₂O at 450° C. for a range of pressures and compositions. Suitable conditions for the present invention are those for which a liquid phase or brine is present, i.e., the regions of the diagram labeled V-L (vapor-liquid equilibrium region), L (single phase liquid region) and L-S (liquid-solid equilibrium region). If the latter region is employed, the occurrence of solid precipitation and potential plugging must be taken into account. The region marked V-S (vapor-solid equilibrium region) must be avoided as no brine exists here and virtually all of the salt would precipitate as solid with the likely result of apparatus plugging. In actual practice the medium would have a number of constituents other than just salt and water and this would affect the phase behavior. For example in a SCWG application, product gases would form a gas or vapor phase even in the regions L or L-S of the binary salt-water system. Nevertheless, the binary phase diagram illustrates the concept of selecting appropriate operating conditions for the present invention.

FIG. 1B shows a diagram analogous to FIG. 1A but for the binary system K₂CO₃—H₂O (data from Ravich et al., Solubility and vapor pressure in the potassium carbonate-water system at elevated temperatures, Russ. J. Inorg. Chem. 13:1000-1004, 1968). A portion of the vapor+liquid equilibrium curve has not been measured and therefore is not shown. While the same phase regions are present as for NaCl—H₂O, the pressure and composition coordinates have shifted considerably. It is of interest to note that, for this system, brines may be maintained at 450° C. and subcritical pressures (<221 bar).

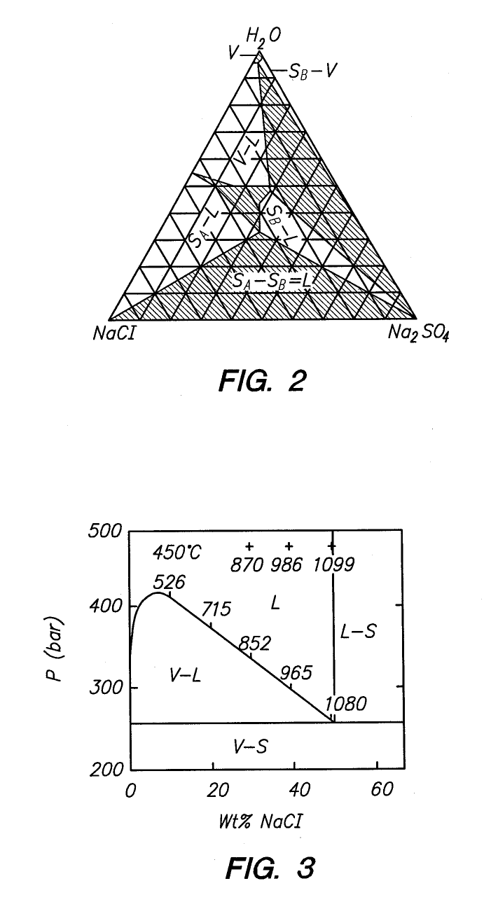

FIG. 1C shows the strikingly different phase behavior for the binary system Na₂CO₃—H₂O. This binary system cannot be used as a basis to practice the present invention as brines do not exist in the region of interest shown in the plot, or even at much higher pressures. Rather, only solid Na₂CO₃ in equilibrium with a nearly pure steam vapor phase is found. However, Na₂CO₃ may still be useful as part of a mixed salt system to practice the present invention as will be illustrated in the discussion of FIG. 2.

FIG. 2 illustrates how the region of suitable operating conditions can be broadened through the use of salt mixtures using the well-studied ternary system NaCl—Na₂SO₄—H₂O. It should first be noted that a phase diagram for the binary system Na₂SO₄—H₂O apparatus at 450° C. would look just like FIG. 1C, with no brines and only V-S equilibrium. With the addition of NaCl to the system, however, high levels of the otherwise insoluble Na₂SO₄ may be retained in a brine. The diagram of FIG. 2 shows phase behavior in the ternary system at 450° C. and 250 bar (from DiPippo et al., Ternary phase equilibria for the sodium chloride-sodium sulfate-water system at 200 and 250 bar up to 400° C., Fluid Phase Equilibria, Vol. 157, pp. 229-255, 1999). Each apex of the triangle represents the pure component noted, while the grid marks along the triangle sides indicate increments of 10 wt %. As shown by the liquid (L) and vapor-liquid (V-L) regions in FIG. 2, brine may be maintained and solid precipitation may be avoided at compositions as high as about 30 wt % Na₂SO₄. Thus, this figure illustrates how precipitation of low solubility salts may be mitigated by the present invention.

FIG. 3 gives an example of the densities of the supercritical brines of interest for the present invention (density data from Urusova, Volume properties of aqueous solutions of sodium chloride at elevated temperatures and pressures, Russ. J. Inorg. Chem. 20:1717-1721, 1975). A section of FIG. 1A has been enlarged with brine densities in kg/m³ noted at a number of points. The densities shown are for NaCl brines, but are representative of the density range of interest, i.e., ˜500 to >1000 kg/m³. Higher formula weight salt compounds and higher salt contents tend to give denser brines.

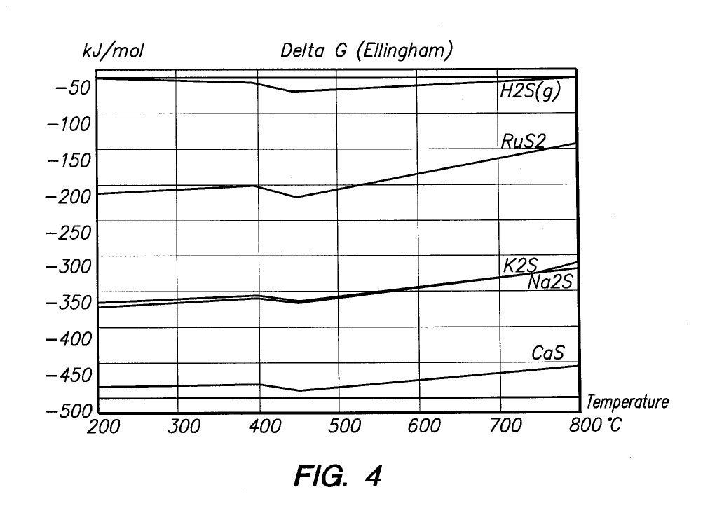

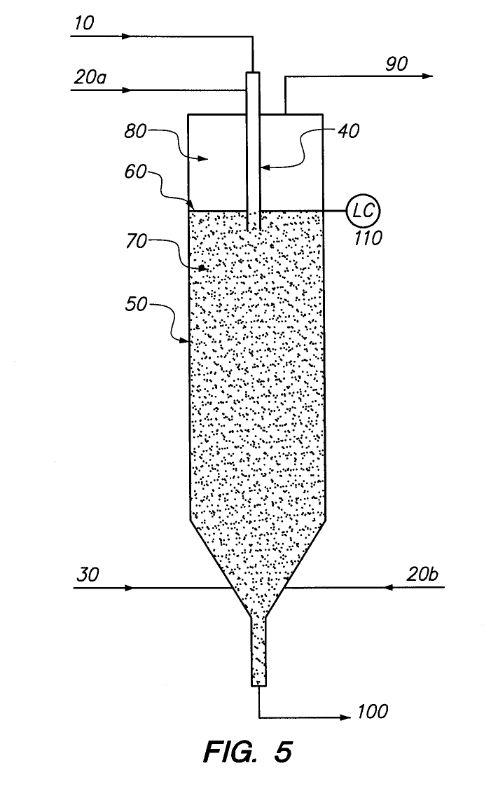

FIG. 4 shows the relative stability of several sulfide compounds relevant to a SCWG process, calculated from free energy of formation thermochemical data over a range of temperatures. Ruthenium sulfide (RuS) has a lower free energy of formation than hydrogen sulfide (H₂S) over the entire range, and thus ruthenium catalyst tends to be “poisoned” by the formation of inactive RuS. However, both sodium sulfide and potassium sulfide have lower free energies of formation over the same temperature range, and thus should form preferentially to RuS. In other words, sodium and potassium should help prevent the formation of ruthenium sulfide and hence protect ruthenium catalyst from sulfide poisoning. This protective effect is enhanced by the high level of sodium and/or potassium that would be available in forming the brine for the present invention. As an alternative approach, other additives that do not comprise the principal brine-forming species may be introduced to provide catalyst protection. CaS is included in FIG. 4 as an example of using a calcium compound such as limestone (CaCO₃) as a sulfur scavenging additive.

FIG. 5 shows a preferred embodiment for a reactor vessel implementing the present invention in a SCWG application. Reactor 50 operates at nominal conditions of 450° C. and 250 bar, and is constructed of a corrosion-resistant material or fitted with a corrosion-resistant liner as is typical practice for SCWG. The reactor 50 may be externally or internally heated as necessary by means well-known in the art (not shown). The reactor 50 is fed by feed stream 10, which may be a pressurized and optionally preheated liquid, slurry, or solid. The feed 10 may also contain makeup salt and/or catalyst as necessary. The feed 10 enters a downcomer pipe 40 that extends below the liquid-vapor interface 60 in order to assure delivery of the feed material 10 to the supercritical brine phase 70, where reaction takes place, without bypassing to the product gas exit pipe 90. In order to make efficient use of the reactor volume, the reactor is primarily filled with supercritical brine. For this purpose, the liquid-vapor interface level is maintained above about 50% of the reactor volume by level controller 110. Other inputs to the reactor 50 may include supercritical water at location 20a and/or 20b and oxidant at location 30. Supercritical water added at location 20a aids in rapid heatup of the incoming feed 10, while supercritical water added at location 20b aids in control of the desired salt concentration in the reactor. In addition, certain feed materials such as plastic use up water as gasification occurs, so that a source of makeup water is required for these instances. Introduction of oxidant to the reactor 50 allows some of the feed 10 or product material to be oxidized to help provide the heat necessary to run the reaction. Product gas accumulates in the reactor head space 80 and exits the reactor 50 through pipe 90 along with supercritical steam, while removal of residual solids and purge of excess dissolved materials is carried out through pipe 100.

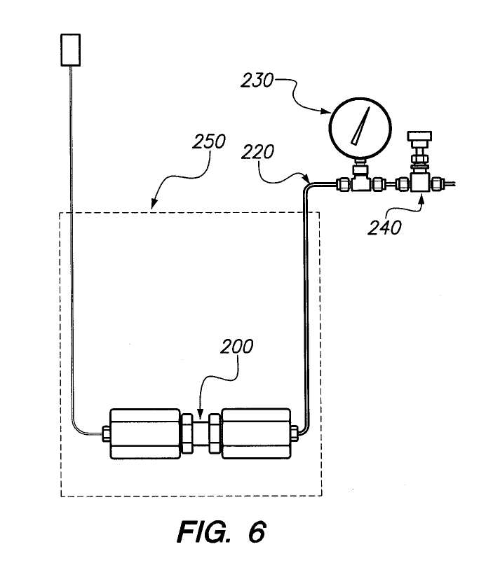

Laboratory-scale batch tests were carried out on the apparatus shown in FIG. 6 to obtain preliminary information on the utility of the present invention for SCW gasification. The test apparatus and procedure are similar to those described by Stucki et al. (Catalytic gasification of algae in supercritical water for biofuel production and carbon capture, Energy Environ. Sci., 2009, 2, 535-541). The apparatus is comprised of an Alloy C-276 mini-batch reactor 200 assembled from 1″ OD×0.6875″ ID cone and thread tubing with end fittings from High Pressure Equipment Co., Erie, Pa. At one end of the reactor 200 is a 0.0625″ OD Type K thermocouple with an Alloy 600 sheath. At the other end of the reactor 200 a 0.125″ OD×0.0040″ ID 316SS tubing 220 connects to a pressure gauge 230 and a sampling valve 240. The total volume of the apparatus is about 35 mL. To carry out a test, the desired amount of feed material (typically 0.300 to 0.425 g), salt, water (or salt solution), and catalyst are added to the mini-batch reactor 200, which is then sealed. The apparatus is then attached to a cylinder of argon and precharged to about 40 bar. The precharge helps prevent excessive reflux of steam during subsequent reactor heatup and is also a useful leak check of the assembly prior to and after the test. After precharging, the apparatus is immersed in a heated fluidized sand bath 250 (Model IFB-51, Techne, Inc., Burlington, N.J.) to bring the reactor 200 to the desired temperature. The reactor 200 is held in the sand bath 250 for the desired period of time and then removed and allowed to air cool in a laboratory hood. Once the reactor 200 has returned to ambient temperature, the change in pressure is noted to allow calculation of the moles of product gas using the ideal gas law. A gas sample is then withdrawn into a gas sample bag and sent for compositional analysis by gas chromatography.

Table 1 provides descriptions of a number of runs carried out on the apparatus of FIG. 6 using maple sawdust feed with a higher heating value of 18330 kJ/kg (7880 Btu/lb). Column 1 indicates the run number while column 2 indicates the maximum temperature achieved. Column 3 indicates the salt or catalyst added and columns 4 and 5 indicate the relative amounts of salt or catalyst and water added. Column 6 shows the maximum pressure attained, which occurred when the maximum temperature of column 2 was attained. As an approximate means of characterizing the temperature profile for each run, a “nominal temperature” corresponding to the highest 25° C. interval attained is given in column 7. Column 8 then shows the minutes elapsed to attain the nominal temperature, while column 9 shows the minutes spent at or above the nominal temperature. Finally, column 10 shows the percent of the energy contained in the feed that was recovered in the gaseous products. Calculation of the results in column 10 utilizes the product gas analytical results shown in Table 2.

TABLE 1
Lab Test Descriptions

| | | | 4 | | | | | | 10 |
|---|---|---|---|---|---|---|---|---|---|
| 1 | 2 | 3 | Salt/ | 5 | 6 | 7 | 8 | 9 | Gas |
| Run | Max | Salt/ | Cat:Feed | H₂O:Feed | Max P | Nominal | Min to | Min ≧ | Energy |
| No. | ° C. | Catalyst | Wt. Ratio | Wt Ratio | bar | T, ° C. | Nom T | Nom T | Recovery % |
| 1 | 380 | None | — | 15.0 | 245 | 375 | 16 | 6 | 9 |
| 2 | 414 | None | — | 15.0 | 321 | 400 | 30 | 14 | 29 |
| 3 | 498 | None | — | 15.0 | 345 | 475 | 7 | 19 | 46 |
| 4 | 381 | Ru | 8.0 | 15.0 | 234 | 375 | 15 | 7 | 47 |
| 5 | 451 | Ru | 8.0 | 15.0 | 317 | 450 | 15 | 2 | 68 |
| 6 | 490 | Ru | 8.0 | 15.0 | 365 | 475 | 7 | 5 | 95 |
| 7 | 393 | NaCl | 5.0 | 15.0 | 226 | 375 | 7 | 15 | 6 |
| 8 | 501 | NaCl | 5.0 | 15.0 | 330 | 500 | 18 | 2 | 34 |
| 9 | 451 | NaOH | 1.0 | 15.0 | 359 | 450 | 19 | 1 | 47 |
| 10 | 504 | NaOH | 1.0 | 15.0 | 348 | 500 | 11 | 5 | 80 |
| 11 | 409 | K₂CO₃ | 1.7 | 15.0 | 269 | 400 | 10 | 7 | 15 |
| 12 | 454 | K₂CO₃ | 1.7 | 15.0 | 355 | 450 | 10 | 4 | 32 |
| 13 | 487 | K₂CO₃ | 1.7 | 15.0 | 372 | 475 | 8 | 8 | 73 |
| 14 | 505 | K₂CO₃ | 1.7 | 15.0 | 359 | 500 | 30 | 35 | 87 |
| 15 | 509 | K₂CO₃ | 1.7 | 15.0 | 345 | 500 | 8 | 4 | 97 |
| 16 | 423 | Na/K₂CO₃ | 1.4 | 15.0 | 279 | 400 | 6 | 6 | 27 |
| 17 | 487 | Na/K₂CO₃ | 1.4 | 15.0 | 334 | 475 | 9 | 8 | 54 |
| 18 | 403 | Ru/K₂CO₃ | 9.7 | 15.0 | 303 | 400 | 12 | 3 | 82 |
| 19 | 434 | Ru/K₂CO₃ | 9.7 | 15.0 | 293 | 425 | 9 | 8 | 84 |
| 20 | 486 | Ru/K₂CO₃ | 9.7 | 15.0 | 303 | 475 | 9 | 8 | 80 |

TABLE 2
Lab Test Analytical Results

| Run No. | H₂ | Ar | O₂ | N₂ | CO | CH₄ | C₂H₆ |
|---|---|---|---|---|---|---|---|
| 1 | 0.237 | 94.49 | 0.614 | 2.310 | 0.295 | 0.100 | 0.015 |
| 2 | 0.477 | 91.11 | 0.891 | 3.350 | 0.486 | 0.425 | 0.064 |
| 3 | 1.750 | 89.50 | 0.696 | 2.620 | 0.515 | 1.030 | 0.180 |
| 4 | 0.378 | 88.10 | 0.595 | 2.240 | 0.000 | 2.880 | 0.200 |
| 5 | 0.330 | 82.50 | 0.898 | 3.380 | 0.000 | 6.690 | 0.052 |
| 6 | 0.687 | 77.26 | 0.739 | 2.780 | 0.000 | 9.970 | 0.062 |
| 7 | 0.226 | 94.97 | 0.532 | 2.000 | 0.115 | 0.079 | 0.022 |
| 8 | 2.300 | 89.54 | 0.758 | 2.850 | 0.000 | 0.595 | 0.100 |
| 9 | 5.350 | 89.63 | 0.875 | 3.290 | 0.000 | 0.580 | 0.130 |
| 10 | 6.070 | 89.23 | 0.572 | 2.150 | 0.000 | 1.410 | 0.210 |
| 11 | 3.010 | 93.06 | 0.635 | 2.390 | 0.000 | 0.147 | 0.045 |
| 12 | 4.640 | 89.28 | 0.824 | 3.100 | 0.000 | 0.543 | 0.150 |
| 13 | 5.500 | 86.65 | 0.851 | 3.200 | 0.000 | 1.480 | 0.240 |
| 14 | 6.020 | 84.61 | 0.891 | 3.350 | 0.000 | 2.200 | 0.360 |
| 15 | 3.160 | 85.75 | 1.495 | 5.625 | 0.000 | 1.580 | 0.250 |
| 16 | 2.210 | 94.22 | 0.585 | 2.200 | 0.000 | 0.131 | 0.036 |
| 17 | 5.350 | 89.04 | 0.662 | 2.490 | 0.000 | 0.796 | 0.150 |
| 18 | 0.232 | 81.84 | 0.758 | 2.850 | 0.000 | 8.670 | 0.083 |
| 19 | 0.301 | 84.05 | 0.845 | 3.180 | 0.000 | 6.600 | 0.048 |
| 20 | 0.314 | 84.21 | 1.090 | 4.100 | 0.000 | 5.980 | 0.030 |
| Run No. | C₃H₈ | C₄ | C₅ | C₆ | C₆₊ | CO₂ | Total |
| 1 | 0.018 | 0.012 | 0.009 | 0.010 | 0.009 | 1.880 | 99.99 |
| 2 | 0.062 | 0.038 | 0.035 | 0.021 | 0.025 | 3.040 | 100.02 |
| 3 | 0.110 | 0.051 | 0.051 | 0.029 | 0.033 | 3.470 | 100.04 |
| 4 | 0.054 | 0.016 | 0.003 | 0.001 | 0.002 | 5.520 | 99.99 |
| 5 | 0.011 | 0.003 | 0.001 | 0.001 | 0.002 | 6.150 | 100.02 |
| 6 | 0.015 | 0.004 | 0.001 | 0.001 | 0.002 | 8.450 | 99.97 |
| 7 | 0.016 | 0.010 | 0.014 | 0.011 | 0.010 | 1.970 | 99.97 |
| 8 | 0.060 | 0.031 | 0.041 | 0.023 | 0.027 | 3.600 | 99.93 |
| 9 | 0.060 | 0.018 | 0.019 | 0.019 | 0.047 | 0.000 | 100.01 |
| 10 | 0.100 | 0.036 | 0.037 | 0.037 | 0.063 | 0.000 | 99.91 |
| 11 | 0.019 | 0.007 | 0.008 | 0.007 | 0.025 | 0.660 | 100.02 |
| 12 | 0.071 | 0.022 | 0.024 | 0.019 | 0.050 | 1.230 | 99.95 |
| 13 | 0.110 | 0.035 | 0.043 | 0.037 | 0.054 | 1.760 | 99.96 |
| 14 | 0.180 | 0.073 | 0.030 | 0.025 | 0.040 | 2.220 | 100.00 |
| 15 | 0.115 | 0.039 | 0.048 | 0.046 | 0.087 | 1.765 | 99.96 |
| 16 | 0.018 | 0.007 | 0.008 | 0.008 | 0.027 | 0.557 | 100.00 |
| 17 | 0.081 | 0.027 | 0.035 | 0.033 | 0.056 | 1.330 | 100.05 |
| 18 | 0.020 | 0.010 | 0.003 | 0.001 | 0.002 | 5.570 | 100.04 |
| 19 | 0.013 | 0.007 | 0.002 | 0.001 | 0.001 | 4.980 | 100.03 |
| 20 | 0.007 | 0.004 | 0.002 | 0.001 | 0.003 | 4.290 | 100.03 |

Comparison of the results in Table 1 gives a preliminary indication of the effectiveness of the present invention. Runs 1-3 show the baseline results at several temperatures when no catalyst or salt is added to the apparatus. Runs 4-6, not a part of the present invention (since a brine phase is not involved), show how improved conversion is attained in the presence of supported ruthenium catalyst (2% Ru on extruded activated carbon pellets from BASF, referred to as Ru/C). The weight ratio of catalyst:feed of 8 includes the weight of the activated carbon support, and it should be noted that activated carbon itself possesses some catalytic activity (see e.g. Nakamura et al., Gasification of chicken manure using suspended activated carbon catalyst in supercritical water, 15^{th} European Biomass Conference and Exhibition Proceedings, 2007). While the Ru/C catalyst is highly effective, it has drawbacks in that it utilizes an expensive precious metal and is subject to poisoning by certain commonly present elements such as sulfur. As previously noted, objects of the present invention include avoidance of the use of precious metal catalysts or, alternatively, protection of precious metal catalysts from poisoning.

Runs 7-8 with the neutral salt NaCl indicate little or no effect on the gasification attained by the baseline case without salt. Nevertheless, NaCl may still prove useful as a phase modifier or catalyst protector when mixed with other active salts or catalysts.

The alkaline compound NaOH is a well-known reactant with catalytic properties for organic decomposition and gasification. Runs 9-10 utilize a relatively large amount of NaOH with a 1:1 ratio of NaOH:wood. As expected, the tests show a substantial increase in gasification as compared to the baseline case. Use of NaOH as a catalyst/reactant in the present invention presents a significant difficulty, however, in that the carbon dioxide produced by the gasification reacts with the NaOH to produce insoluble solid Na₂CO₃; in fact Runs 9 and 10 include insufficient NaOH to obtain the full benefits of the present invention because all of the sodium is tied up as Na₂CO₃ part way through the gasification, with resultant disappearance of the brine phase. Nevertheless, brine is present for the initial portion of the gasification providing a partial indication of the advantages of the present invention. To obtain the full benefits of the present invention when using NaOH, the brine phase must be maintained by continual addition of fresh NaOH (a considerable expense for a full-scale plant), or mixed with one or more other salts to keep the Na₂CO₃ in solution, or both. Another noteworthy point is the absence of CO₂ in the gas analysis results for Runs 9 and 10 in Table 2. As the reactor cools down below 270° C., sodium bicarbonate (NaHCO₃) becomes stable and any excess CO₂ is captured by the Na₂CO₃.

The alkaline compound K₂CO₃ is another material known to catalyze gasification reactions (see e.g. Sinag et al., Influence of the heating rate and the type of catalyst on the formation of key intermediates and on the generation of gases during hydropyrolysis of glucose in supercritical water in a batch reactor, Ind. Eng. Chem. Res. 2004, 43, 502-508). The same molar ratio of catalyst:feed was used as with NaOH, and Runs 11-15 also show a substantial increase in gasification as compared to the baseline case. K₂CO₃ is advantageous compared to NaOH because it acts as a true catalyst and is not consumed in the reactor. Furthermore, unlike Na₂CO₃, K₂CO₃ remains soluble in the supercritical brine as was previously shown in FIG. 1. The effectiveness of the high level of K₂CO₃ used rivals that of the ruthenium and indicates that use of expensive precious metal catalyst can be avoided with the present invention.

A mixture of the dry salts Na₂CO₃ and K₂CO₃ has a eutectic melting point of 710° C. at about 57 mol % Na₂CO₃. Although data for the phase behavior of this salt mixture under high water pressure at supercritical temperatures is not available, by analogy with other known ternary water-salt-salt systems, the presence of water is expected to lower the minimum melting temperature and shift the corresponding composition slightly. Runs 16-17 were carried out with an equimolar mixture of Na₂CO₃ and K₂CO₃ to see if any beneficial effects were observed. The gasification appears to be a bit less than with K₂CO₃ alone, which may be due to selection of a non-optimal salt mixture. However, it is possible that sodium will be more active than potassium in some cases and that use of a mixture of Na₂CO₃ and K₂CO₃ could have certain advantages that are not apparent in Table 1.

Runs 18-20 were carried out with a mixture of K₂CO₃ and Ru/C to see if any synergistic effects were observed with both catalysts present. The mixture appears to give improved performance at lower temperatures, but about the same performance at higher temperatures. In actual practice, however, where contaminants such as sulfur may be present, the mixture of K₂CO₃ and Ru/C may provide superior performance at all conditions since poisoning of the Ru/C would be prevented by the K₂CO₃, as previously noted in conjunction with FIG. 4.

It must be borne in mind that the laboratory batch apparatus is limited by its relatively slow heatup time and by the limited amount of brine present. It is anticipated that a continuous flow apparatus with more rapid heatup and excess brine as previously shown in FIG. 5 will yield higher conversions than those observed in the laboratory batch tests.

While the examples given are for use of wood biomass as a feed material, it is anticipated that the present invention will prove advantageous for all types of organic materials, including other types of biomass, municipal sludge and biosolids, coal, and waste plastic.

While the particular Method and Apparatus for High Temperature Brine Phase Reactions as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for processing a feed material which comprises the steps of:
forming and maintaining a brine phase with water and at least one soluble inorganic compound;
creating a pressure on the brine phase less than 500 bar;
heating the brine phase to a temperature greater than 374° C., with an established density for the brine phase greater than 700 kg/m³; and
introducing the feed material into the brine phase for reaction therewith to produce an effluence.

2. A method as recited in claim 1 wherein the soluble inorganic compound is selected to prevent deposition of low solubility compounds.

3. A method as recited in claim 1 further comprising the step of including a catalyst in the brine phase.

4. A method as recited in claim 3 further comprising the step of selecting the soluble inorganic compound to protect the catalyst from poisoning.

5. A method as recited in claim 3 further comprising the step of adding to the brine a compound to protect the catalyst from poisoning.

6. A method as recited in claim 3 wherein the catalyst is an alkaline compound selected from a group comprising K₂CO₃ and NaOH, and wherein the effluence is a gas.

7. A method as recited in claim 3 wherein the catalyst is a precious metal.

8. A method as recited in claim 1 wherein the inorganic compound is selected from a group comprising salts, oxide compounds and hydroxide compounds and wherein the method further comprises the step of collecting and disposing of the product effluence resulting from the reaction.

9. A method as recited in claim 1 further comprising the step of injecting a fluid into the feed material during the introducing step, wherein the injected fluid has a temperature greater than 374° C., and is selected from a group comprising water and brine.

10. A method as recited in claim 1 further comprising the step of removing residual solids and excess dissolved materials from the brine phase.

11. A method as recited in claim 1 wherein the brine phase comprises:
water;
at least one soluble inorganic compound; and
a catalyst.

12. A method as recited in claim 1 further comprising the step of augmenting the brine phase with an oxidant.

13. An apparatus for processing a feed material which comprises:
a source of the feed material;
a reactor vessel formed with a chamber for holding a brine phase therein, wherein the brine phase is maintained at a temperature greater than 374° C., under a pressure less than 500 bar, with an established density greater than 700 kg/m³;
a level controller to maintain the brine level at a point corresponding to at least half of the reactor vessel volume;
a means for introducing the feed material into the brine phase, for reaction therewith to produce an effluence; and
an exit pipe connected in fluid communication with the chamber for removing the effluence therefrom.

14. An apparatus as recited in claim 13 wherein the means for introducing is a downcomer pipe connecting the source of feed material in fluid communication with the chamber of the reactor vessel.

15. An apparatus as recited in claim 13 wherein the brine phase and a gaseous effluence coexist in the chamber with a liquid/vapor interface therebetween, wherein the downcomer pipe extends through the gaseous effluence and past the interface into the brine phase, and wherein the exit pipe is in fluid communication with only the gaseous effluence.

16. An apparatus as recited in claim 14 further comprising an injection pipe connected to the downcomer pipe for injecting a fluid into the feed material, wherein the fluid has a temperature greater than 374° C. to rapidly preheat the feed material, and is selected from a group comprising water and brine.

17. An apparatus as recited in claim 13 further comprising an injection pipe in fluid communication with the chamber of the reactor vessel for use in injecting a fluid into the brine phase for control of the brine phase, wherein the injected fluid has a temperature greater than 374° C., and is selected from a group comprising water and brine.

18. An apparatus as recited in claim 13 further comprising an oxidant pipe in fluid communication with the chamber of the reactor vessel for use in adding an oxidant to the brine phase.

19. An apparatus as recited in claim 13 further comprising a drain pipe for removing residual solids and excess dissolved materials from the brine phase.

20. A method for processing a feed material which comprises the steps of:
providing a water mixture having a density greater than 500 kg/m³, at a temperature greater than 374° C.; and
introducing a feed material into the water mixture for reaction therewith to produce an effluence.

21. A method as recited in claim 20 further comprising the step of forming the water mixture as a brine phase by maintaining the brine phase with at least one soluble inorganic compound, wherein the inorganic compound is selected from a group comprising salts, oxide compounds and hydroxide compounds and wherein the method further comprises the step of collecting and disposing of the product effluence resulting from the reaction.

22. A method as recited in claim 20 further comprising the step of adding a catalyst to the brine phase, and wherein the effluence is a gas.

23. A method as recited in claim 20 further comprising the step of augmenting the brine phase with an oxidant.
